(19) United States
(12) Patent Application Publication
(10) Pub. No.: US 2021/0409859 A1
(43) Pub. Date: Dec. 30, 2021

(54) INTEGRATED CAR SEAT EAR BUDS DEVICE

(71) Applicant: Johel Farkas, Brooklyn, NY (US)

(72) Inventor: Johel Farkas, Brooklyn, NY (US)

(21) Appl. No.: 16/914,371

(22) Filed: Jun. 28, 2020

(51) Int. Cl. H04R 1/10; H04W 4/80; B60N 2/879

(52) U.S. Cl. CPC H04R 1/1033; H04R 1/1016; H04R 2420/07; B60N 2/879; H04W 4/80

(57) ABSTRACT

An integrated car seat ear buds device including a pair of Bluetooth ear buds, a control unit and a pair of retractable wiring cords. The pair of Bluetooth ear buds are integrated within the headrest region of the car seat. The control unit controls the operation of the Bluetooth ear buds. The pair of retractable wiring cords are embedded within the headrest of the car seat. The pair of retractable wiring cords are configured to retract into the headrest, in a default position, and upon a first manual manipulation of the pair of retractable wiring cords and are configured to extend outwards from the headrest upon a second manipulation of the pair of retractable wiring cords. Each Bluetooth ear bud is attached to a distal end of a corresponding retractable wiring cord.

### FIELD OF THE INVENTION

Embodiments described herein generally relate to an accessory for a car seat, and more particularly to an integrated car seat ear buds device.

### BACKGROUND OF THE INVENTION

Bluetooth ear buds are a common electronic accessory in this day and time, but they can easily be misplaced due to their miniature size. Furthermore, either forgetting to charge the Bluetooth headset before use or the charge running out too fast are frequent issues that Bluetooth headset owners experience that often prohibit them from using the device when in transit or other occasions. Hence, it is desirable to overcome the aforementioned shortcomings of Bluetooth ear buds.

### BRIEF DESCRIPTION OF THE DRAWINGS

The various advantages of the embodiments of the present disclosure will become apparent to one skilled in the art by reading the following specification and appended claims, and by referencing the following drawing(s), in which:

FIG. 1 shows an exemplary view of an integrated car seat ear buds device according to an embodiment of the present disclosure.

### SUMMARY OF THE INVENTION

Exemplary embodiments disclosed herein describe an integrated car seat ear buds device including a pair of Bluetooth ear buds, a control unit and a pair of retractable wiring cords. The pair of Bluetooth ear buds are integrated within the headrest region of the car seat. The control unit controls the operation of the Bluetooth ear buds. The pair of retractable wiring cords are embedded within the headrest of the car seat. The pair of retractable wiring cords are configured to retract into the headrest, in a default position, and upon a first manual manipulation of the pair of retractable wiring cords and are configured to extend outwards from the headrest upon a second manipulation of the pair of retractable wiring cords. Each Bluetooth ear bud is attached to a distal end of a corresponding retractable wiring cord.

In some exemplary embodiments, the control unit is positioned on the right side retractable wiring cord.

In some exemplary embodiments, the control unit controls turning the pair of Bluetooth ear buds on and off.

In some exemplary embodiments, the control unit controls the volume of sound in the pair of Bluetooth ear buds.

In some exemplary embodiments, the pair of retractable wiring cords are connected to the power supply source of the car.

### DETAILED DESCRIPTION

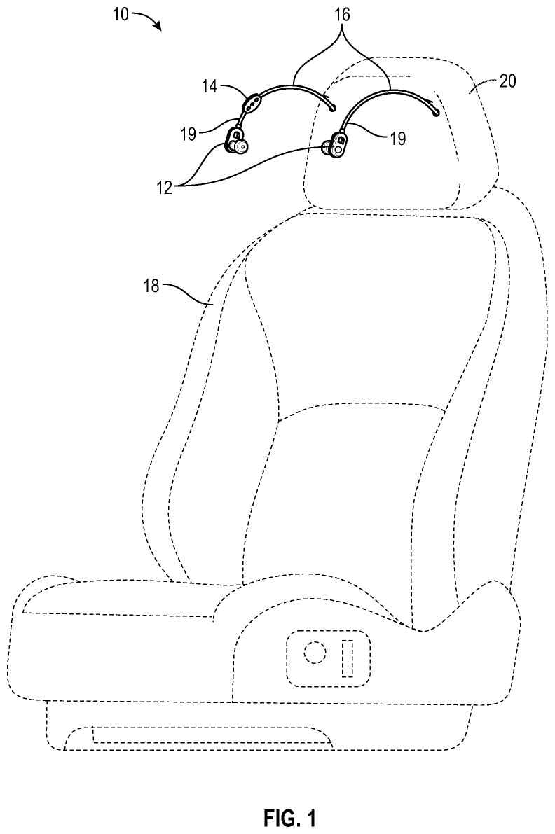

The present disclosure relates to an integrated car seat ear buds device (“the device”). The device is integrated into the headrest of a car seat and is readily available for use each time a person gets into the car. As illustrate in FIG. 1, the device 10 includes a pair of Bluetooth ear buds 12, a control unit 14, and a pair of retractable wiring cords 16. The pair of Bluetooth ear buds are attached to a distal end 19 of a corresponding retractable wiring cord 16. Any suitable ear buds may be used.

The control unit 14 may be positioned on the right side retractable wiring cord 16. The control unit may include a plurality of buttons for controlling the operation of the pair of Bluetooth ear buds. The control unit controls turning the pair of Bluetooth ear buds on and off. Moreover, the control unit controls the volume of sound in the pair of Bluetooth ear buds.

The pair of retractable wiring cords 16 are embedded within the headrest 20 of the car seat 18. The pair of retractable wiring cords are configured to retract into the headrest 20 in a default position and upon a first manual manipulation of the pair of retractable wiring cords and are configured to extend outwards from the headrest 20 upon a second manipulation of the pair of retractable wiring cords. The first manual manipulation of the pair of retractable wiring cords may include a slight jerking motion of each retractable wiring cord. The second manual manipulation of the pair of retractable wiring cords may include a pulling motion of the pair of retractable wiring cords. The pair of retractable wiring cords are each connected to the power supply source of the car. Moreover, each retractable wiring cord is attached to a spring mechanism embedded within the headrest 20 for retracting and extending each retractable wiring cord.

Moreover, it should be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.)

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

Those skilled in the art will appreciate from the foregoing description that the broad techniques of the embodiments of the present invention may be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

1. An integrated car seat ear buds comprising:
a pair of Bluetooth ear buds integrated within a headrest region of a car seat;
a control unit for controlling the operation of the Bluetooth ear buds, the control unit including a housing, which is positioned on a retractable wiring cord, having a plurality of buttons for controlling the operation of the pair of Bluetooth ear buds; and
a pair of retractable wiring cords which are embedded within the headrest of the car seat, the pair of retractable wiring cords are configured to retract into the headrest, in a default position, and upon a first manual manipulation of the pair of retractable wiring cords from the default position the pair of retractable wiring cords are configured to extend outwards from the headrest and maintain an extended outwards position by way of a spring mechanism attached to the pair of retractable wiring cords and upon a second manual manipulation of the pair of retractable wiring cords from an extended outward position, the pair of retractable wiring cords are configured to automatically retract into the headrest by way of the spring mechanism; wherein each Bluetooth ear bud is attached to a distal end of a corresponding retractable wiring cord.

2. The device of claim 1, wherein the control unit is positioned on the right side retractable wiring cord.

3. The device of claim 1, wherein at least one of the plurality of buttons on the control unit controls turning the pair of Bluetooth ear buds on and off.

4. The device of claim 1, wherein at least one of the plurality of buttons on the control unit controls the volume of sound in the pair of Bluetooth ear buds.

5. The device of claim 1, wherein the pair of retractable wiring cords are connected to the power supply source of the car.
